(19) United States
(12) Patent Application Publication
(10) Pub. No.: US 2009/0207128 A1
(43) Pub. Date: Aug. 20, 2009

(54) Digital Electrophoretic Display Panel Driving Method and Apparatus

(75) Inventors: Hsin-Chung CHEN, Taipei City (TW); Feng-Chuan YEH, Taipei City (TW); Po-Sen CHEN, Taipei City (TW); Rui-Yang LAI, Taipei City (TW)

Correspondence Address: SCHMEISER OLSEN & WATTS, 18 E UNIVERSITY DRIVE, SUITE # 101, MESA, AZ, 85201, US

(73) Assignee: Prime View International Co., Ltd., Hsinchu City (TW)

(21) Appl. No.: 12/356,253

(22) Filed: Jan. 20, 2009

(30) Foreign Application Priority Data
Feb. 15, 2008 (TW) 097105267
Aug. 15, 2008 (TW) 097131297

(51) Int. Cl. G09G 3/34

(52) U.S. Cl. 345/107

(57) ABSTRACT

The present invention discloses a digital electrophoretic display panel driving method and apparatus, the driving device digitally reads a setup value from a memory unit to eliminate manual adjustment to save labor and to avoid manual adjustment error, and also to reduce a voltage error of a common electrode voltage (Vcom). The digital electrophoretic display panel driving device comprises a panel driving memory disposed on the electrophoretic display panel and coupled with a connecting circuit for a system board to read the data in the panel driving memory via the connecting circuit.

### BACKGROUND OF THE INVENTION

1. Field of the Invention

The present invention relates to a digital electrophoretic display panel driving device and a method thereof, and more particularly, to a driving device and a method for an electrophoretic display (electronic paper).

2. Description of the Prior Art

An electrophoretic display (EPD) or so-called electronic paper is different from conventional papers. EPD is made of conductive polymer material comprising many “microspheres” (or microcapsules), which is flexible and capable of repeatedly displaying data thereon. In the field of electronic paper techniques, the size of the micro capsules represents the size of the pixels; in addition micro capsules tend to change their states as driven by an external voltage. The US patent publication No. 20060050050 discloses a electronic ink display whose conductivity can change as driven by an external voltage, therefore the material of the electronic ink display must be conductive; meanwhile, the electronic ink display uses polymer material to provide flexibility and can be bent like paper.

The EPD is advantageous in that its brightness is three to six times of that of reflective color LCD for people to easily read it in the dark or under direct sunlight; the contrast of the EPD is higher than that of newspaper with no limitation in its viewing angle.

The EPD is able to display content even after the power is off, which means the battery life of the portable device can be extended; the power consumption of the EPD is only 1/1000 compared to the display of a notebook computer as it does not require backlight.

Furthermore, as the contents of the EPD displays are printed on paper the reader will not get tired easily as compared with reading contents from the LCD display. In addition EPD is thinner and lighter than the common LCD display.

According to Wikipedia, EPD was first developed in the 1970s by Nick Sheridon at Xerox's Palo Alto Research Center. The first electronic paper, called Gyricon, consisted of polyethylene spheres between 20 and 100 micrometres across. Each sphere is composed of negatively charged black plastic on one side and positively charged white plastic on the other. The polarity of the voltage applied to each pair of electrodes then determines whether the white or black side is face-up, thus giving the pixel a white or black appearance

Later, the second generation of EPD uses microcapsules each containing positively charged white particles and negatively charged black particles (known as E ink) suspended in a clear fluid. When a negative electric field is applied, the white particles move to the top of the microcapsule where they become visible to the user. This makes the surface appear white at that spot. At the same time, an opposite electric field pulls the black particles to the bottom of the microcapsules where they are hidden. By reversing this process, the black particles appear at the top of the capsule, which now makes the surface appear dark at that spot. In other words, one microcapsule can display two different colors. These microcapsules are suspended in a liquid “carrier medium” allowing them to be printed onto virtually any surface, including glass, plastic, fabric and even paper.

Since the EPD is highly portable, reusable, fast to update, low cost and even provides hand written input, therefore the emerging electronic paper will bring about a revolution to the publishing industry. People can carry electronic papers that update news or information at any time, any place, and can modify the documents as desired. More importantly, electronic papers help to conserve the environment and reduce consumption of paper, the current annual consumption is over 200 million tons, in order to maintain ecological balance.

Furthermore, the EPD changes traditional media. The Japanese government announced that it intends to digitally transmit news to every user's computer for users to browse the contents using specific software and to even download the contents to their electronic papers via wireless networks. Forrester Research said that electronic paper stands a chance to replace the popular LCD displays and change the way people read.

However, development in EPD still presents several issues to be overcome such as production cost, durableness, driving voltage, reliability, and response time. Although all kinds of publishing materials are now undergoing the digitization process and various devices are being developed to display digital content, one problem remained to be solved is how to make the reading experience with electronic papers similar to that of conventional papers. This involved improving electronic paper in terms of readability for text/images, rewritablity for documents, and less power consumption in displaying and storage.

In prior art EPD panel driving methods, please refer to the flowchart in FIG. 1A, each EPD panel is slightly different due to parameters, material, packaging or environment in the front end process (10), therefore panel suppliers will provide different common electrode voltages (Vcom) (11). Hence, in driving each EPD panel, it is necessary to adjust the Vcom on the system board. The back end process for EPD panels (12) is to cut the EPD display panel and to integrate it with other components such as capacitors, driving IC, frame, flexible printed circuit and so on, then in system manufacturing process, the Vcom of the EPD is modified manually by adjusting the variable resistor (13). Then the waveform voltage value is written to the memory in the system board (14). After the system verifies the displaying contents (15, 16), the waveform voltage values are read from the memory in the system board and combined with the Vcom to display contents (18). Please refer to the electrophoretic display panel driving device in FIG. 1B, manually adjusting variable resistor (111) prevents loading effect from affecting the Vcom, therefore the buffer circuit (112) is used for outputting voltage to switch input/output terminals. The controller chip is provided for controlling the output of the common electrode voltage switch (114) to the output terminal (115).

### SUMMARY OF THE INVENTION

It is an objective of the present invention to provide a digital electrophoretic display panel driving method and apparatus to reduce the time required in adjusting the variable resistor when replacing the electrophoretic display panel; and to facilitate panel usage of the electrophoretic display. The prior art techniques manually adjust the variable resistor to change the common electrode voltage (Vcom), which could lead to long adjustment time and large amounts of labor; besides, there is the risk of misadjustment or manual error problems.

In order to achieve the above objective, the present invention provides a digital electrophoretic display panel driving method and apparatus. The new method reads the setup value digitally from the memory without manual adjustment to save time and labor and to reduce the voltage error of the common electrode voltage (Vcom), since the digital voltage error is less than the voltage error adjusted by the variable resistor.

The prior art EPD is driven by adjusting the variable resistor. When it is going through a maintenance or a production test, the Vcom setup value of the system board should match that of the panel, therefore it could lead to wasted time in searching for suitable panels.

The present invention reads the Vcom from the memory in the panel, it is convenient for the maintenance worker or the tester since they do not need to find matched panels or to re-adjust the variable resistor.

### BRIEF DESCRIPTION OF THE DRAWINGS

Please refer to the following description and figures for further understanding of the present invention and its objectives, wherein:

FIG. 1A illustrates a flowchart of a method for driving a traditional electrophoretic display panel;

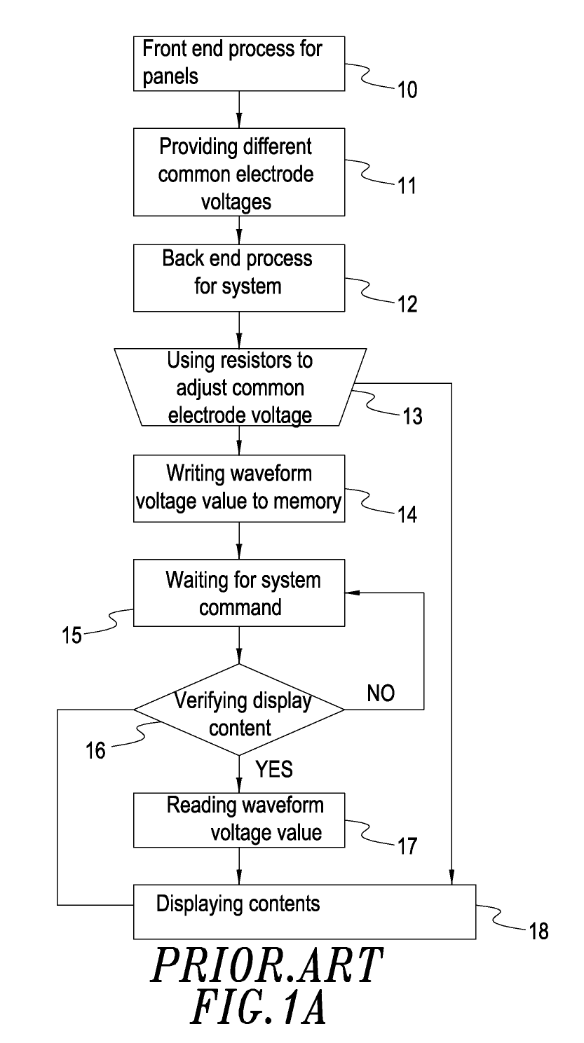

FIG. 1B illustrates a structural view of the traditional electrophoretic display panel;

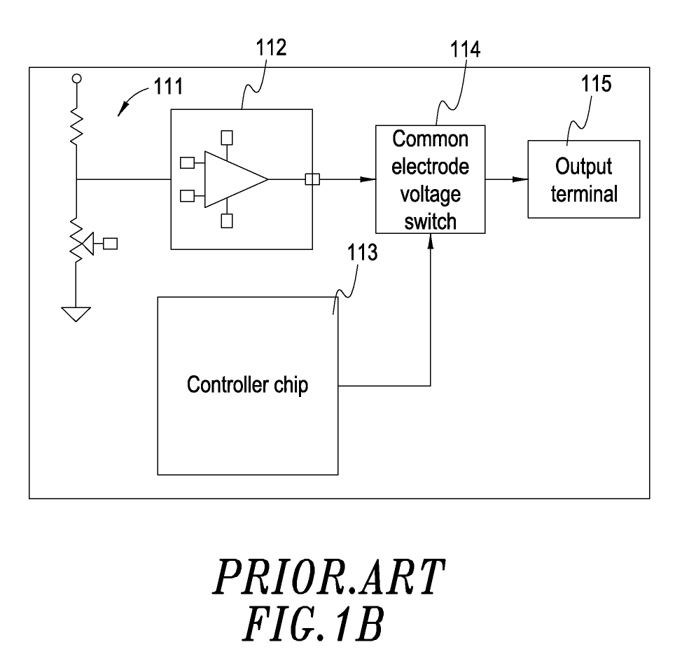

FIG. 2A illustrates a structural view of a digital electrophoretic display panel driving device;

FIG. 2B illustrates another structural view of a digital electrophoretic display panel driving device;

FIG. 3 illustrates a block diagram of an electrophoretic display panel;

FIG. 4 illustrates a flowchart of a method for driving an electrophoretic display panel; and

FIG. 4A illustrates a view of how to convert the memory data of a digital electrophoretic display into a common electrode voltage;

FIG. 4B illustrates another view of how to convert the memory data of a digital electrophoretic display into a common electrode voltage.

### DETAILED DESCRIPTION OF THE PREFERRED EMBODIMENT

The advantages and innovative features of the invention will become more apparent from the following detailed description when taken in conjunction with the accompanying drawings.

The present invention provides a digital electrophoretic display panel driving method and apparatus to use a memory unit to store common electrode voltage (Vcom) setup values and the panel driving data. The present invention digitally reads the setup value from the memory unit without manual adjustment to save time/labor and to avoid manual error. The digital electrophoretic display (EPD) panel driving device comprises a panel driving memory disposed on the EPD for storing digital panel driving data, and a connecting circuit for a controller chip to read the data in the panel driving memory via the connecting circuit.

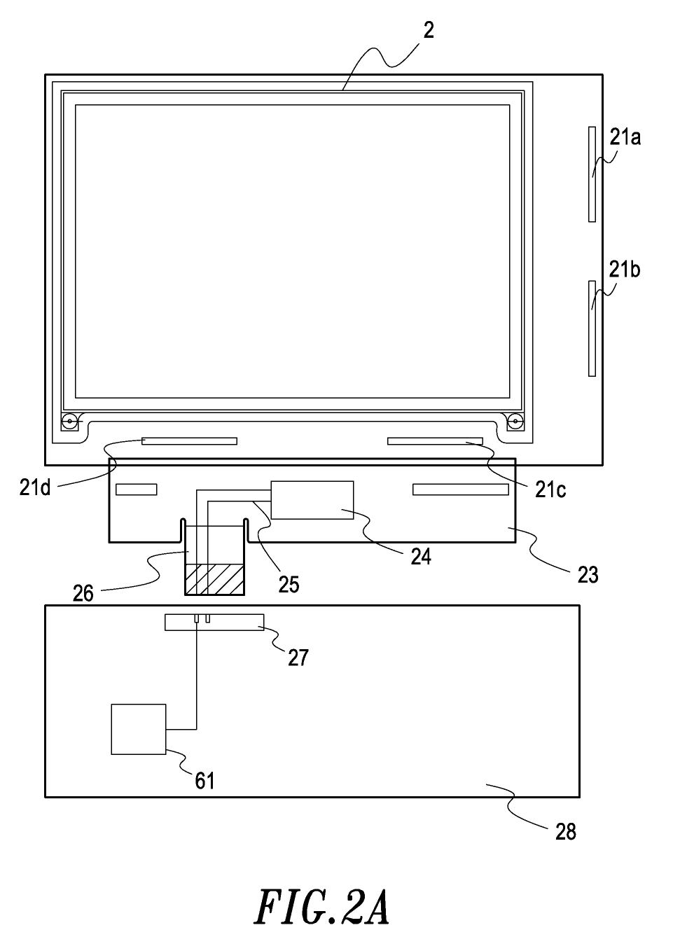

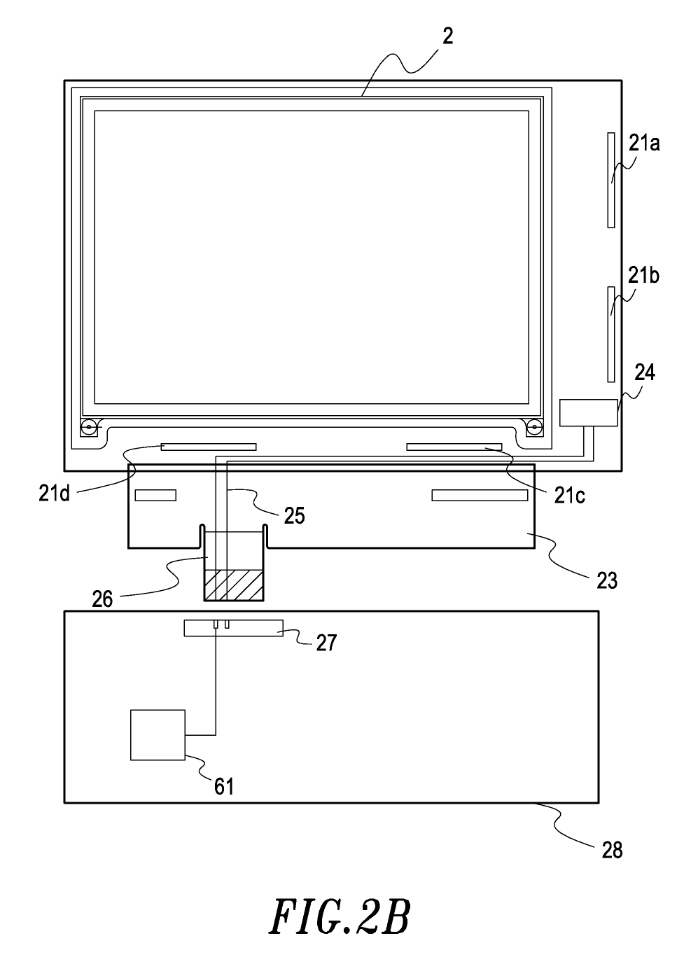

Please refer to the embodiment of FIG. 2A, wherein a flexible printed circuit (23) of the electrophoretic display panel (2) is added to a panel driving memory (24) thereon, and the NC pin of the flexible printed circuit tail (26) is added with a memory IC (25) connecting with a controller chip (61).

Please refer to the embodiment of FIG. 2B, wherein a glass of the electrophoretic display panel (2) is added to the panel driving memory (24) thereon, and the NC pin of the flexible printed circuit tail (26) is added with a memory IC (25) connecting with the controller chip (61).

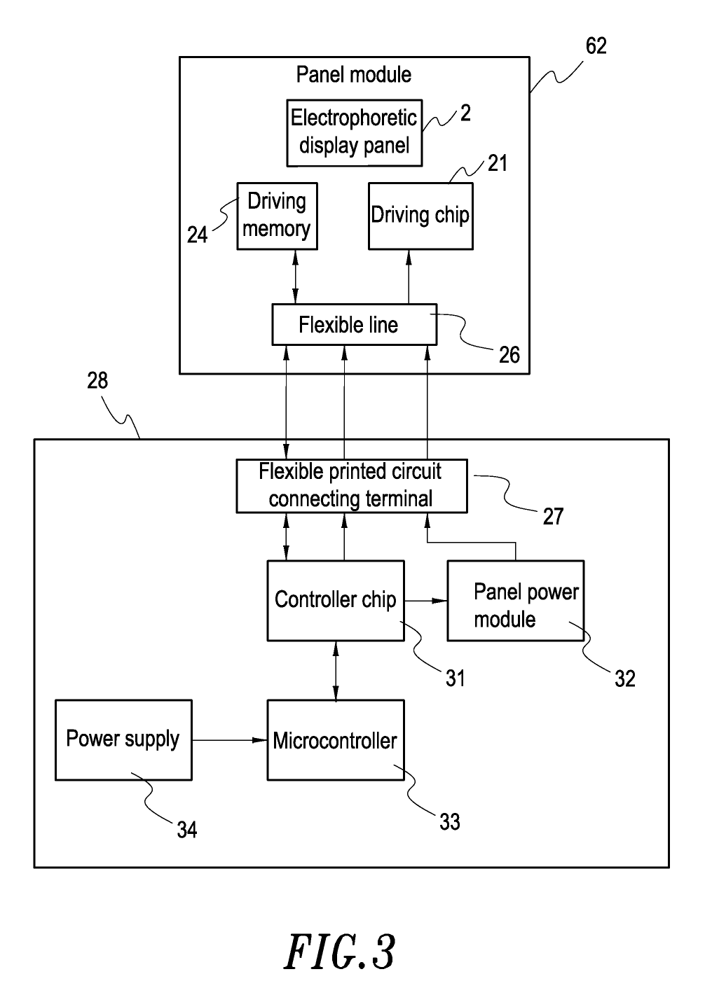

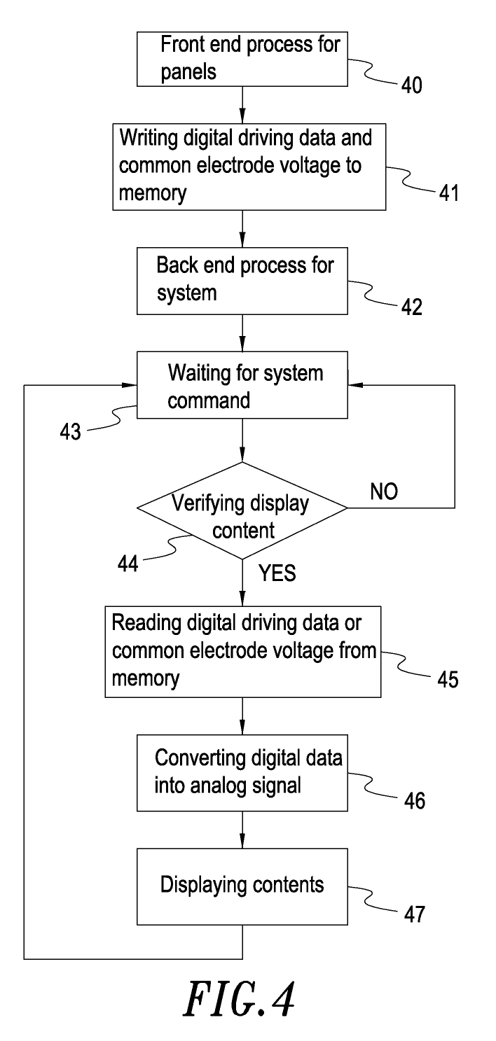

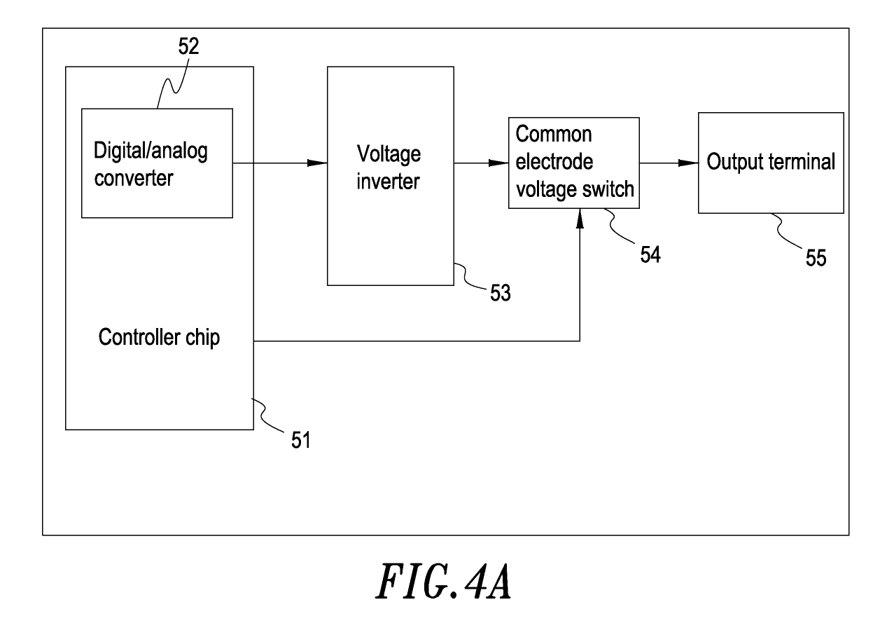

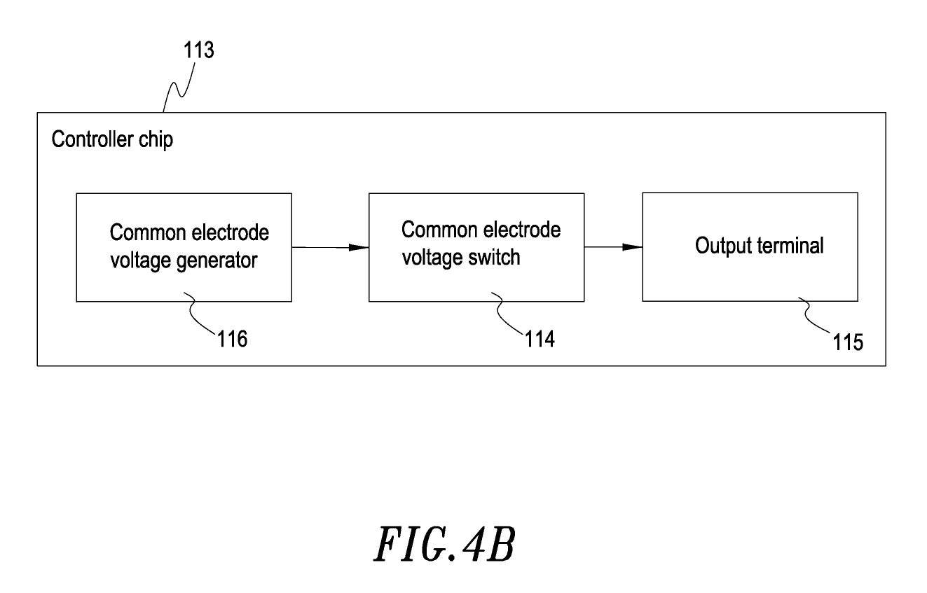

Since each EPD panel is slightly different due to parameters, material, packaging or environment in the front end process, therefore it is necessary to use different common electrode voltages (Vcom) in driving different EPD panels. The back end process for EPD panels is to cut the EPD display panel and to integrate it with other components such as capacitors, driving IC, frame, flexible printed circuit and so on, then in system manufacturing process, the Vcom of the EPD is modified manually by adjusting the variable resistor. The present invention provides a digital electrophoretic display panel driving method and apparatus to store different common electrode voltages (Vcom) of EPD panels in memory; besides, the memory can be used for storing driving voltage waveform values. As illustrated by Taiwan patent application No. 096127424, which provides an active EPD driving method, the present invention discloses a plurality of sub pixels aligned in a matrix, wherein a single or a plurality of pixels are sequentially driven. When an image is inputted, the invention obtains a grey level value for each pixel and sequentially drives the pixels. First, apply driving voltages to convert all pixels into one of the two predefined grey level values. Later, sequentially drive the pixels based on pre-defined resolution; calculate the time and the voltages required for driving the pixels from one grey level value to another grey level value to accelerate the display speed of the EPD. Next, adjust the total driving time of each grey level value to increase or reduce the driving time for each grey level value respectively, in doing this, it is useful to control the display of each grey level value. The driving time or the driving voltage data can be stored on the memory of the EPD panel. Please refer to the embodiment in FIG. 3, a power supply (34) provides power to a microcontroller (MCU)(33), the controller chip (31) reads the data from the panel driving memory (24) via the FPC tail (26) and the flexible printed circuit connecting terminal (27), and the controller chip (31) uses the panel power module (32) to provide power to the electrophoretic display panel (2) on the panel module (62). After the data is read, it is converted by the controller chip into an analog voltage signal for the driving chip (21) to drive the EPD. Please refer to FIG. 4 for a flowchart of a method for driving the EPD panel. Since each EPD panel is slightly different due to parameters, material, packaging or environment in the front end process (40), therefore it is necessary to use different common electrode voltages (Vcom) (41) provided by the panel supplier to drive different EPD panels and to store digital driving data and the Vcom in the driving memory. The back end process (42) for EPD panels is to cut the EPD display panel and to integrate it with other components such as capacitors, driving IC, frame, flexible printed circuit and so on, then the EPD is driven according to the following steps:

Step 1 (44): verifying the data displayed by a system, the system calculates and integrates data from different sources to represent the result through graphics, the system verifies the image presented to the user in this step;

Step 2 (45): the controller chip reading the digital panel driving data from the panel driving memory; wherein different common electrode voltages (Vcom), driving time or driving voltages provided by the panel supplier are stored in the memory, the digital electrophoretic display panel driving device comprises a panel driving memory disposed on the EPD panel, and also comprises a connecting circuit for a controller chip on the system board to read the data in the panel driving memory via the connecting circuit;

Step 3 (46): the controller chip converting the digital panel driving data read from the panel driving memory into an analog voltage signal;

Step 4 (47): the controller chip sending the analog voltage signal to a driving integrated circuit on the EPD panel to drive the EPD panel.

Please refer to the embodiment in FIG. 4A, wherein the controller chip (51) uses a digital/analog converter (52) in the controller chip to convert the digital panel driving data read from the panel driving memory into an analog voltage signal and to control the common electrode voltage switch (54) to send the analog voltage signal from the voltage inverter (53) via an output terminal (55) to the driving integrated circuit on the display panel.

Please refer to the embodiment in FIG. 4B, wherein the controller chip (113) uses the common electrode voltage generator (116) in the controller chip (113) to send the digital panel driving data in the panel driving memory to the common electrode voltage switch (114) for outputting a common electrode voltage via an output terminal (115) to the driving integrated circuit on the display panel.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A digital electrophoretic display panel driving device, comprising:
a panel driving memory disposed on an electrophoretic display for storing digital panel driving data; and
a connecting circuit for a controller chip to read data from the panel driving memory via the connecting circuit.

2. A digital electrophoretic display panel driving method, comprising the steps of:
first: verifying the data displayed by a system;
second: the controller chip reading the digital panel driving data from the panel driving memory;
third: the controller chip converting the digital panel driving data read from the panel driving memory into an analog voltage signal; and
fourth: the controller chip sending the analog voltage signal to a driving integrated circuit on the panel to drive the panel.

3. The digital electrophoretic display panel driving method as claimed in claim 2, wherein in the third step the controller chip uses a digital/analog converter in the controller chip to convert the digital panel driving data read from the panel driving memory into an analog voltage signal and to control the common electrode voltage switch to send the analog voltage signal from the voltage inverter via an output terminal to the driving integrated circuit on the display panel.

4. The digital electrophoretic display panel driving method as claimed in claim 2, wherein the controller chip controls the output of the analog voltage signal.

5. The digital electrophoretic display panel driving method as claimed in claim 3, wherein the controller chip controls the output of the analog voltage signal.

6. The digital electrophoretic display panel driving method as claimed in claim 2, wherein in the third step the controller chip uses the common electrode voltage generator in the controller chip to send the digital panel driving data in the panel driving memory to the common electrode voltage switch for outputting a common electrode voltage to the driving integrated circuit on the display panel.

7. The digital electrophoretic display panel driving method as claimed in claim 3, wherein in the third step the controller chip uses the common electrode voltage generator in the controller chip to send the digital panel driving data in the panel driving memory to the common electrode voltage switch for outputting a common electrode voltage to the driving integrated circuit on the display panel.

8. The digital electrophoretic display panel driving device as claimed in claim 1, wherein the panel driving memory is disposed on a flexible printed circuit on the electrophoretic display panel.

9. The digital electrophoretic display panel driving device as claimed in claim 1, wherein the panel driving memory is disposed on an electrophoretic display panel glass on the electrophoretic display panel.

10. The digital electrophoretic display panel driving method as claimed in claim 4, wherein in the third step the controller chip uses the common electrode voltage generator in the controller chip to send the digital panel driving data in the panel driving memory to the common electrode voltage switch for outputting a common electrode voltage to the driving integrated circuit on the display panel.

11. The digital electrophoretic display panel driving method as claimed in claim 5, wherein in the third step the controller chip uses the common electrode voltage generator in the controller chip to send the digital panel driving data in the panel driving memory to the common electrode voltage switch for outputting a common electrode voltage to the driving integrated circuit on the display panel.
